(19) United States
(12) Patent Application Publication
(10) Pub. No.: US 2022/0297335 A1
(43) Pub. Date: Sep. 22, 2022

(54) PAPERBOARD STRUCTURES AND METHODS FOR MANUFACTURING PAPERBOARD STRUCTURES

(71) Applicant: Multi Packaging Solutions, Inc., Atlanta, GA (US)

(72) Inventors: Mathew D. Dickman, Plainfield, IL (US); Christopher B. Knight, Plainsfield, IN (US)

(21) Appl. No.: 17/565,005

(22) Filed: Dec. 29, 2021

Related U.S. Application Data
(60) Provisional application No. 63/131,847, filed on Dec. 30, 2020.

(51) Int. Cl. B26F 1/18; D21H 27/30; D21H 21/32

(52) U.S. Cl. CPC B26F 1/18; D21H 27/30; D21H 21/32

(57) ABSTRACT

A method for manufacturing a paperboard structure configured to snap apart. The paperboard structure has a first surface and a second surface. The method includes defining first line along the first surface of the paperboard structure. The first line extends a first cut depth D₁ through the paperboard structure. The method further includes cutting a second line along the second surface of the paperboard structure. The second line extends a second cut depth D₂ through the paperboard structure. The second line is offset from the first line by a first offset distance D_{O1}.

### FIELD

The present disclosure generally relates to paperboard structures and, more particularly, to paperboard snap cards and methods for manufacturing paperboard snap cards.

### BACKGROUND

Gift cards are commonly used as a disposable means of gifting. Gift cards are typically comprised of a plastic material such as polyvinyl chloride. They typically have a configuration including an upper portion with printed information and a hole for hanging on a display rack and a lower portion that is configured to snap apart from the upper portion.

One drawback is the disposable nature of gift cards. They are generally used for a short period of time as a means of gifting and are thrown in the trash after use by the recipient. Current materials used to manufacture gift cards include plastic materials that are non-recyclable, not repulpable, and thus are not environmentally friendly. Current recyclable alternatives do not offer the snap away mechanism that is provided by plastic materials and, thus, are not ideal for the snap away design of traditional gift cards.

Accordingly, those skilled in the art continue with research and development efforts in the field of biodegradable paperboard structures, particularly in the field of snap away gift cards.

### SUMMARY

Disclosed are methods for manufacturing a paperboard structure having a first surface and a second surface.

In one example, the disclosed method includes steps of (1) cutting a first line along the first surface of the paperboard structure, the first line extending a first cut depth D₁ through the paperboard structure; and (2) cutting a second line along the second surface of the paperboard structure, the second line extending a second cut depth D₂ through the paperboard structure, the second line is offset from the first line by a first distance D_{O1}.

Also disclosed are paperboard structures.

In one example, the disclosed paperboard structure includes a first surface and a second surface. The first surface includes a first line extending a first cut depth D₁ through the paperboard structure. The second surface includes a second line extending a second cut depth D₂ through the paperboard structure. The second line is offset from the first line by a first width W₁.

Other examples of the disclosed paperboard structures and methods will become apparent from the following detailed description, the accompanying drawings, and the appended claims.

### BRIEF DESCRIPTION OF THE DRAWINGS

FIG. 1 is a flowchart of depicting an example of the disclosed method for manufacturing a paperboard structure;

FIGS. 2A, 2B and 2C are top plan views of an example of the disclosed paperboard structure;

FIG. 3 is a bottom plan view of the paperboard structure of FIG. 2A;

FIG. 4 is a bottom plan view of the paperboard structure of FIG. 2A, shown in a separated (e.g., snapped apart) configuration; and

FIG. 5 is a cross-sectional view of a portion of the paperboard structure of FIG. 2A.

### DETAILED DESCRIPTION

Detailed descriptions of specific embodiments of the paperboard structure and method for manufacturing the paperboard structure are disclosed herein. It will be understood that the disclosed embodiments are merely examples of the way in which certain aspects of the invention can be implemented and do not represent an exhaustive list of all the ways the invention may be embodied. As used herein, the word “exemplary” is used expansively to refer to embodiments that serve as illustrations, specimens, models, or patterns. It will be understood that the paperboard structure and methods described herein may be embodied in various and alternative forms. Any specific structural and functional details disclosed herein are not to be interpreted as limiting, but merely as a basis for the claims and as a representative basis for teaching one skilled in the art to variously employ the invention.

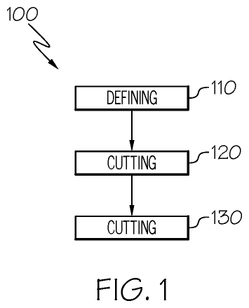

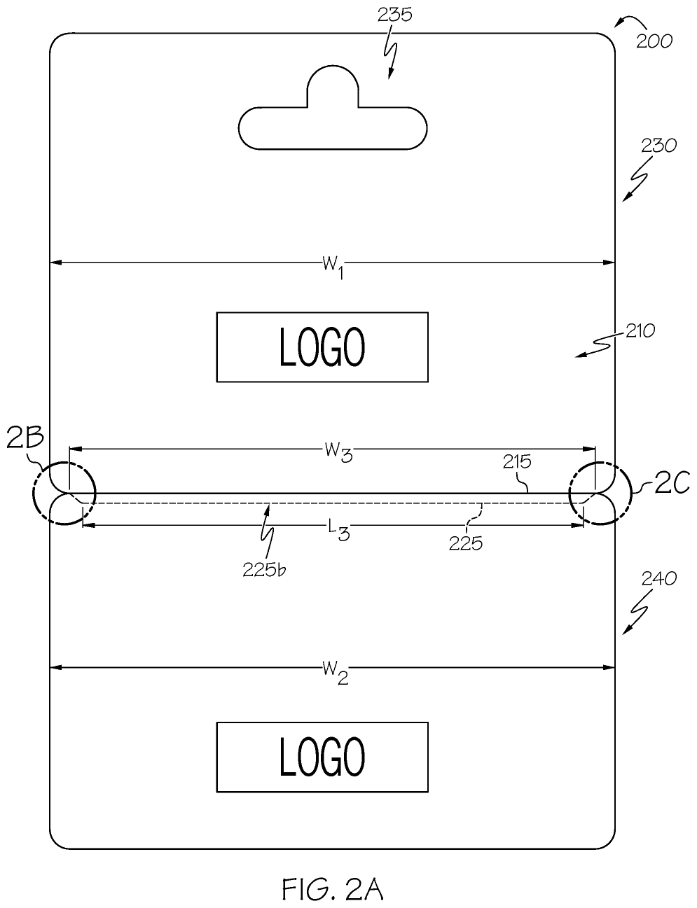

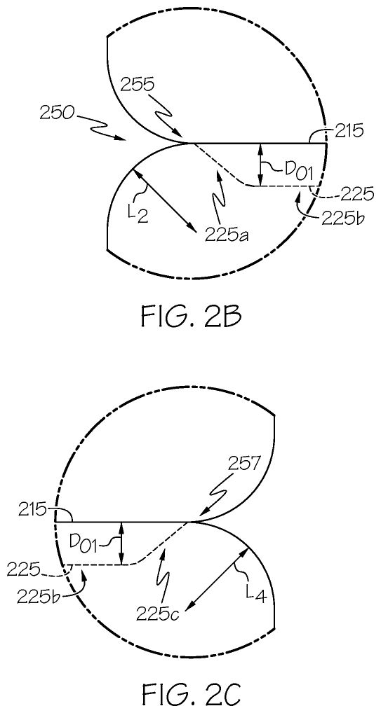

Referring to FIG. 1 and FIGS. 2A-2C, disclosed is a method 100 for manufacturing a paperboard structure 200 having a first surface 210 and an opposing second surface 220. The paperboard structure 200 comprises a paperboard substrate 205. The paperboard structure 200 is configured to snap apart into two pieces. In one or more examples, the method 100 comprises defining 110 an upper portion 230 and a lower portion 240 of the paperboard structure 200. The upper portion 230 has a first width W₁ and the lower portion 240 has a second width W₂. In one or more examples, the first width W₁ and the second width W₂ are substantially equivalent.

Referring to FIGS. 2A-2C, the upper portion 230 and the lower portion 240 are separable along a central portion 250 having a third width W₃. In one or more examples, the third width W₃ is less than the first width W₁. In one or more examples, the third width is less than the second width W₂. In one or more examples, the third width W₃ is defined by a first line 215. In one or more examples, the third width W₃ is defined by a first transition region 255 and a second transition region 257. The first transition region 255 and the second transition region 257 are defined by the juncture between the upper portion 230 and the lower portion 240. The upper portion 230 and the lower portion 240 may be generally rectangular and have generally curved corners that meet at the first transition region 255 and the second transition region 257. The defining 110 may comprise cutting a paperboard structure 200 to define the upper portion 230 and lower portion 240 with a knife, die cutting apparatus, press, or any other suitable means of cutting a paperboard substrate 205 to the desired shape.

Referring to FIG. 1 and FIGS. 2A-2C, in one or more examples, the method 100 comprises cutting 120 a first line 215 along the first surface 210 of the paperboard structure 200. The cutting 120 comprises cutting the first surface 210 to define the first line 215. The first line 215 is generally straight. The first line 215 may be a continuous cut or a perforated cut. The cutting 120 may be achieved with a knife, a die-cutting apparatus, a press, or any other suitable means for cutting through a portion of the paperboard substrate 205 along the first surface 210. The first line 215 extends a first cut depth D₁ through the paperboard substrate 205. In one or more examples, the first cut depth D₁ is approximately 0.01-0.02 inches deep. In one or more examples, the first cut depth D₁ is approximately 0.010-0.012 inches deep. In one or more examples, the first cut depth D₁ is approximately 0.01076 inches deep.

Referring to FIG. 1 and FIGS. 2A-2C, in one or more examples, the method 100 comprises cutting 130 a second line 225 along the second surface 220 of the paperboard structure 200. The second line 225 extends a second cut depth D₂ through the paperboard substrate 205 of the paperboard structure 200. The second line 225 may be a continuous cut or a perforated cut. The cutting 130 may be achieved by cutting the second surface 220 with a knife, a die-cutting apparatus, a press, or any other suitable means for cutting through a portion of the paperboard substrate 205 to define a second line 225.

In one or more examples, the cutting 120 and the cutting 130 are performed simultaneously. In one or more examples, the cutting 120 and the cutting 130 are performed sequentially. In one or more examples, the defining 110, cutting 120, and cutting 130 are performed simultaneously. In one or more examples, the defining 110, cutting 120, and cutting 130 are performed sequentially.

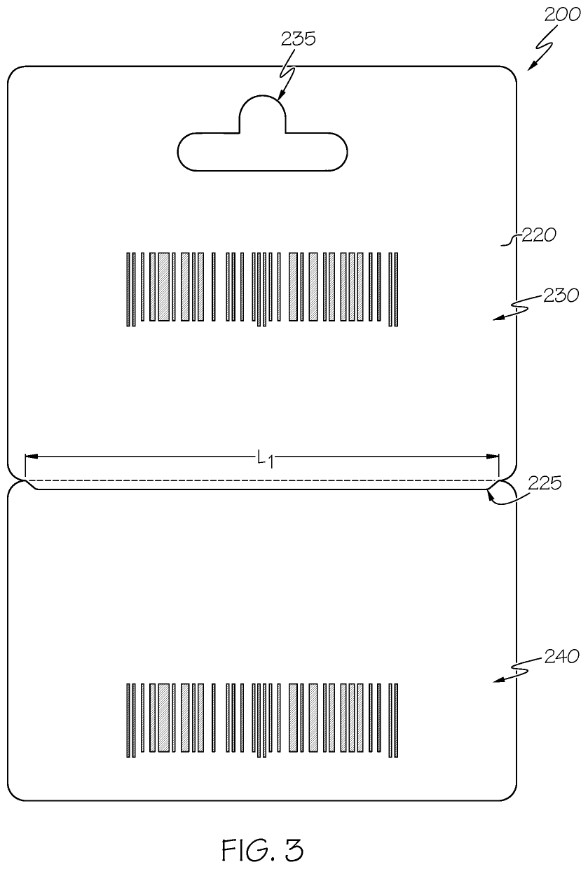

Referring to FIGS. 2A-2C and FIG. 3, the second line 225 comprises three portions. In one or more examples, the second line 225 comprises a first end portion 225a, a middle portion 225b, and a second end portion 225c. In one or more examples, the first end portion 225a and the second end portion 225c project from opposing ends of the middle portion 225b at an angle toward the first line 215.

Referring to FIGS. 2A-2C, the first line 215 and the second line 225 may be located within the central portion 250. In one or more examples, one of the first line 215 and the second line 225 may be located within the central portion 250 and the other may be offset from the central portion 250. In one or more examples, first line 215 is located within the central portion 250 and the second line 225 is offset from the first line 215 by an offset distance D_{O1}. In one or more examples, the offset distance D_{O1} is approximately 0.03-0.07 inches. In one or more examples, the offset distance D_{O1} is approximately 0.0625 inches.

Also disclosed is a paperboard structure 200. Referring to FIGS. 2A-2C, the paperboard structure 200 comprises a first surface 210 and a second surface 220 that is opposed from the first surface 210. The paperboard structure 200 is defined by several cuts that define an upper portion 230 and a lower portion 240. The upper portion 230 and lower portion 240 are removably connected to each other such that they are configured to snap apart upon force applied by a user. The paperboard structure 200 may be generally rectangular in shape, although other shapes are contemplated and may be employed, and may have generally rounded or generally squared corners. In one or more examples, the upper portion 230 comprises a hole 235. The hole 235 extends through entire thickness of the paperboard structure 200 and may be used to hang the paperboard structure 200 for display.

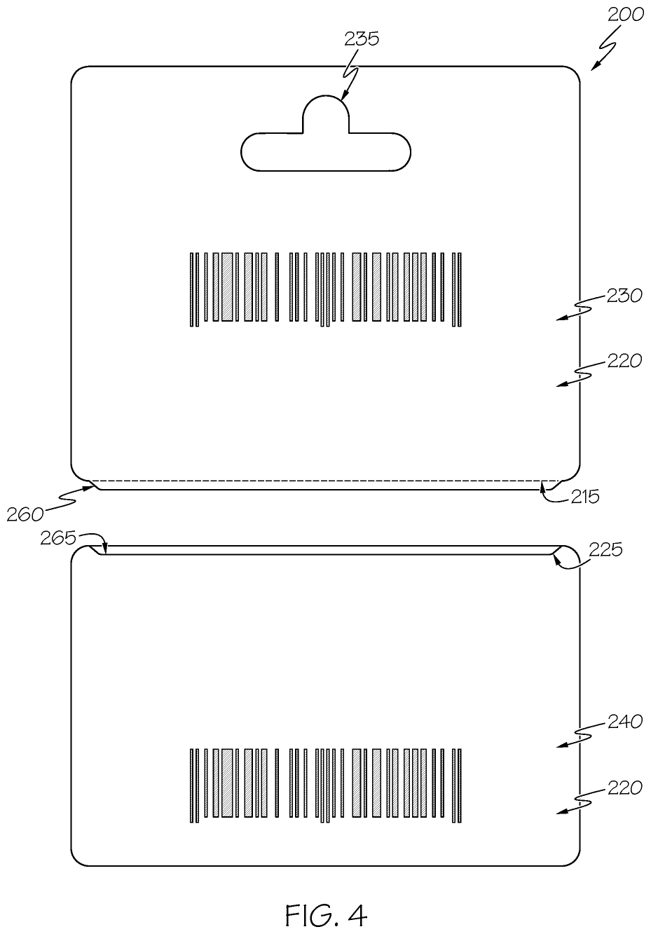

In one or more examples, the paperboard structure 200 is a snap away gift card. Referring to FIGS. 2A, 3, and 4, in one or more examples, the upper portion 230 and the lower portion 240 comprise indicia that renders the paperboard structure 200 useful as a gift card/stored value card/redeemable card. In one or more examples, at least one of the upper portion 230 and the lower portion 240 comprises advertising indicia on the first surface 210. The advertising indicia may comprise a logo, a number indicating the value of the gift card, a holiday message such as a birthday greeting or the like, or any other desired indicia or design indicating that it is a gift card. In one or more examples, at least one of the upper portion 230 and lower portion 240 comprises indicia on the second surface 220. The indicia my comprise advertising material such as a logo, a barcode for redeeming the value of the gift card, a barcode for confirming possession of the gift card in the event the opposing portion is lost, space for writing a gift message and gift card amount, or any other desired indicia or design indicating that it is a gift card.

Referring to FIGS. 2A-2C, FIG. 4, and FIG. 6, the first surface 210 comprises a first line 215. The first line 215 extends a first length L₁. In one or more examples, the first length L₁ is substantially the same as W₃. The first line 215 extends a first cut depth D₁ through the paperboard substrate 205 of the paperboard structure 200. In one or more examples, the first cut depth D₁ is approximately 0.01-0.02 inches deep. In one or more examples, the first cut depth D₁ is approximately 0.010-0.012 inches deep. In one or more examples, the first cut depth D₁ is approximately 0.01076 inches deep.

Referring to FIGS. 2A-2C, FIG. 3, and FIG. 6, the second surface 220 comprises a second line 225. The second line 225 extends a second cut depth D₂ through the paperboard substrate 205 of the paperboard structure 200. In one or more examples, the second cut depth D₂ is approximately 0.002-0.010 inches. In one or more examples, the second cut depth D₂ is approximately 0.004-0.008 inches. In one or more examples, the second cut depth D₂ is approximately 0.00619 inches.

Referring to FIG. 3, in one or more examples, the second line 225 comprises a first end portion 225a, a middle portion 225b, and a second end portion 225c wherein the first end portion 225a and the second end portion 225c are angled toward the first line 215. In one or more examples, the middle portion 225b is substantially parallel to the first line 215. The first end portion 225a and the second end portion 225c extend from opposing ends of the middle portion 225b at an angle and intersect with the first line 215 approximately at the first transition region 255 and the second transition region 257, respectfully. In one or more examples, the second line 225 extends a second length L₂ along the first end portion 225a, a third length L₃ along the middle portion 225b, and a fourth length L₄ along the second end portion 225c. In one or more examples, the second length L₂ and the fourth length L₄ are substantially the same.

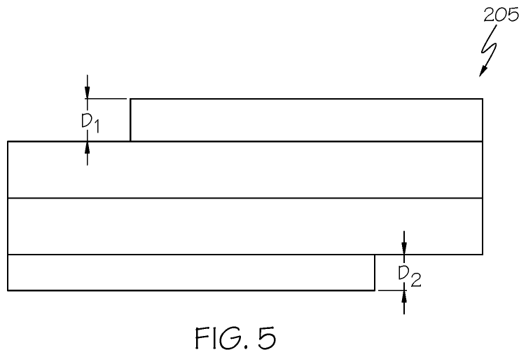

Referring to FIG. 5, the paperboard structure 200 is separated along the first line 215 and the second line 225 such that the upper portion 230 and the lower portion 240 are no longer connected. Once separated, or snapped apart, the upper portion 230 comprises a tab 260 defined by the second line 225 on the second surface 220. The tab 260 extends from the upper portion 230 and has a width that is approximately equivalent to the second cut depth D₂. The lower portion 240 is generally rectangular in shape after being snapped apart from the upper portion 230 and has a notched portion 265 that is substantially the same shape and thickness as the tab 260. In one or more examples, the paperboard structure 200 is a gift card wherein the lower portion 240 becomes a card portion and the upper portion 230 becomes a display portion after the paperboard structure is snapped apart.

Referring to FIG. 6, the paperboard structure 200 comprises a paperboard substrate 205 that is made of renewable materials. Examples of appropriate paperboard substrate 205 materials include corrugated medium, linerboard, solid bleached sulfate (SBS), unbleached kraft, and folding boxboard (FBB). One example of an appropriate paperboard substrate 205 that is commercially available is Envi 28 pt. Card Stock by Monadnock® of Bennington, N.H., USA. In one or more examples, the paperboard substrate 205 comprises 7 pt plies of paperboard stock. In one or more examples, the paperboard substrate 205 comprises at least three plies of paperboard stock laminated together with an adhesive. In one or more examples, the paperboard substrate 205 comprises at least four plies of paperboard stock laminated together with an adhesive. In one or more examples, the paperboard substrate 205 comprises at least five plies of paperboard stock laminated together with an adhesive. In one or more examples, the paperboard substrate 205 comprises at least six plies of paperboard stock laminated together with an adhesive. In one or more examples, the paperboard substrate 205 comprises at least seven plies of paperboard stock laminated together with an adhesive.

Although various examples of the disclosed paperboard structures and methods have been shown and described, modifications may occur to those skilled in the art upon reading the specification. The present application includes such modifications and is limited only by the scope of the claims.

What is claimed is:

1. A method for manufacturing a paperboard structure having a first surface and a second surface opposed from the first surface, the method comprising:
cutting a first line along the first surface of the paperboard structure, the first line extending a first cut depth through the paperboard structure; and
cutting a second line along the second surface of the paperboard structure, the second line extending a second cut depth through the paperboard structure, the second line is offset from the first line by a first offset distance.

2. The method of claim 1 wherein the paperboard structure comprises solid bleach sulfate.

3. The method of claim 1 wherein the paperboard structure comprises a paperboard substrate having at least four plies of 7 pt paperboard stock laminated together with an adhesive.

4. The method of claim 1 wherein the first offset distance is approximately 0.03-0.07 inches.

5. The method of claim 1 wherein the second line comprises:
a first end portion;
a middle portion, the middle portion is substantially parallel to the first line; and
a second end portion, wherein the first end portion and the second end portion project from opposing ends of the middle portion at an angle toward the first line.

6. The method of claim 1 wherein the paperboard structure is a snap card.

7. The method of claim 1 comprising, prior to the cutting:
defining an upper portion and a lower portion of the paperboard structure.

8. The method of claim 7 wherein the upper portion comprises a hole.

9. The method of claim 7 wherein the upper portion and lower portion are configured to snap apart along the first line and the second line.

10. The method of claim 1 wherein the cutting and cutting are performed simultaneously.

11. The method of claim 1 wherein the cutting and cutting are performed sequentially.

12. A paperboard structure comprising:
a first surface having a first line, the first line extending a first cut depth through the paperboard structure;
a second surface opposed from the first surface having a second line, the second line extending a second cut depth through the paperboard structure;
an upper portion; and
a lower portion removably connected to the upper portion along the first line and the second line.

13. The paperboard structure of claim 12 wherein the first line and the second line are offset by an offset distance.

14. The paperboard structure of claim 13 wherein the offset distance is approximately 0.03-0.07 inches.

15. The paperboard structure of claim 12 wherein the first cut depth is approximately 0.01-0.02 inches deep.

16. The paperboard structure of claim 12 wherein the first cut depth is approximately 0.010-0.012 inches.

17. The paperboard structure of claim 12 wherein the second cut depth is approximately 0.002-0.010 inches.

18. The paperboard structure of claim 12 wherein the second cut depth is approximately 0.004-0.008 inches.

19. The paperboard structure of claim 12 wherein the second line comprises:
a first end portion;
a middle portion, the middle portion is substantially parallel to the first line; and
a second end portion, wherein the first end portion and the second end portion project from opposing ends of the middle portion at an angle toward the first line.

20. The paperboard structure of claim 12 wherein the upper portion has a first width and the lower portion has a second width.

21. The paperboard structure of claim 20 wherein the first width and the second width are substantially equivalent.

22. The paperboard structure of claim 12 comprising a paperboard substrate of 28 pt solid bleached substrate.
